(19) United States
(12) Patent Application Publication
(10) Pub. No.: US 2016/0207654 A1
(43) Pub. Date: Jul. 21, 2016

(54) DEVICE IN A FILLING MACHINE

(71) Applicant: TETRA LAVAL HOLDINGS & FINANCE S.A., Pully (CH)

(72) Inventors: Niklas TEGMAN, Höllviken (SE); Göran HERMODSSON, Staffanstorp (SE); Tobias WEGBRANT, Furulund (SE); Mattias DARMELL, Malmö (SE); Johnny MÅNSSON, Hyllinge (SE)

(73) Assignee: TETRA LAVAL HOLDINGS & FINANCE S.A., Pully, OT (CH)

(21) Appl. No.: 14/915,070

(22) PCT Filed: Jul. 18, 2014
(86) PCT No.: PCT/EP2014/065464

§ 371 Date: Feb. 26, 2016

(30) Foreign Application Priority Data
Aug. 28, 2013 (SE) 1350988-0

(51) Int. Cl. B65B 51/30; B65B 61/06; B26D 7/26; B26D 1/00; B26D 7/00

(52) U.S. Cl. CPC B65B 51/30; B26D 1/0006; B26D 7/0006; B26D 7/2614; B65B 61/06; B26D 2001/0053; B26D 2001/006

(57) ABSTRACT

The present invention relates to a knife for a sealing jaw arrangement of a filling machine, the knife in use being provided in a first member, and designed to cooperate with a groove of a second member. The knife further has a body being provided with a cutting edge on one side thereof, the body further comprising a guide. The guide is configured to enter the groove for controlling a movement, in use, of the cutting edge into the groove, and the guide is configured to enter the groove before the cutting edge enters the groove. The invention further relates to a sealing jaw assembly having such a knife.

### FIELD OF THE INVENTION

The invention relates to a knife, and in particular a knife for a filling machine for separating packages from a tube of laminated packaging material.

### BACKGROUND OF THE INVENTION

In filling machines for liquid food packages, such as sold by Tetra Pak® under the name Tetra Pak A1, a web of packaging material is sterilized, and is subsequently formed into a tube by making the longitudinal edges of the web overlap each other and sealing the overlap area. This tube is filled with liquid food continually, and the tube of packaging material is transversally sealed and cut such that separate packages with liquid food are formed. The cutting of packages is an important aspect of the filling machine, since the cut packages need to be separated from the tube in a timely and reliable manner. For certain package formats, the specifics of the packaging material and sealing operation may lead to a more difficult cutting operation, which may lead to unreliable and/or delayed separation of packages.

### SUMMARY OF THE INVENTION

The invention provides an improved cutting knife for a sealing jaw arrangement of a filling machine. The knife is in use provided in a first member, and is designed to cooperate with a groove of a second member. The knife has a body provided with a cutting edge on one side thereof, which cutting edge is configured to cut through a packaging material. The body is further comprising a guide, said guide being configured to enter the groove for controlling a movement of the cutting edge into the groove. The guide is configured to enter the groove before the cutting edge enters the groove.

In one or more embodiments two guides are provided on the body on either side of the cutting edge.

In one or more embodiments the first member is a pressure jaw and the second member is a heating jaw.

In one or more embodiments the cutting edge is single-bevelled.

In one or more embodiments the guide is double-bevelled.

In one or more embodiments the cutting edge has an arrow shape with a tip.

In one or more embodiments the tip is configured to contact the packaging material first, before the rest of the cutting edge, and cut through a packaging material overlap area.

In one or more embodiments the tip is located in the middle of the cutting edge.

In one or more embodiments the cutting edge is serrated.

In one or more embodiments the body is configured to have asymmetric attachment points.

In one or more embodiments one of the attachment holes of the body has a different shape than the other attachment hole.

The invention also provides for a sealing jaw assembly comprising a pressure jaw and a heating jaw, having a knife according to any one of claims 1-11.

### BRIEF DESCRIPTION OF THE DRAWINGS

The invention will be further described with reference to a preferred embodiment, as shown in the drawings in which:

FIG. 1 shows a top view of a steel plate for making a knife according to the invention,

FIG. 2 shows a top view of a knife according to the invention,

FIG. 3 shows a sectional view of the cutting edge of the knife,

FIG. 4 shows a sectional view of a guide of the knife,

FIG. 5 shows a perspective view of a pressure jaw that houses the knife of the invention,

FIG. 6 shows a perspective view of a heating jaw that cooperates with the pressure jaw,

FIG. 7 shows a sectional view of an inductor of the heating jaw,

FIG. 8 shows a sectional view of a part of the inductor and the guide, during use,

FIG. 9 shows a sectional view of a part of the inductor and the cutting edge, during use, and

FIG. 10 shows a part of a tube of packaging material and the knife of the invention.

### DETAILED DESCRIPTION OF THE INVENTION

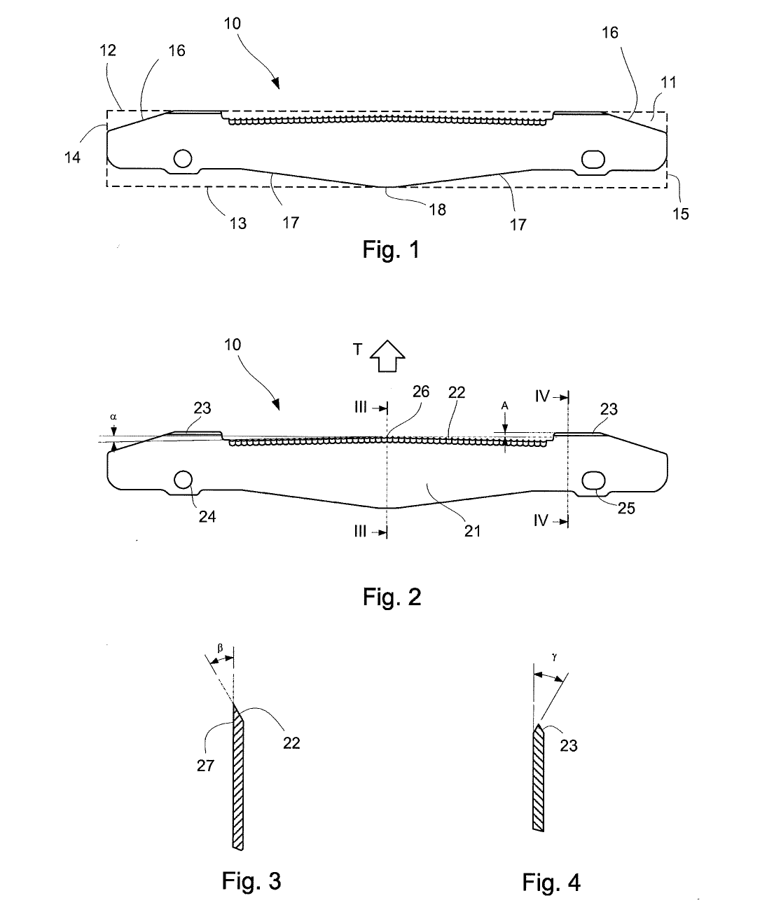

The present invention relates to a knife 10 for a sealing jaw in a filling machine, such as Tetra Pak® A1, for producing liquid food packages, being utilized to separate a continuous tube of packaging material and product into individual packages, in connection with the sealing of said tube, such as transversal sealing. The knife 10 is typically made from a stainless steel plate 11, indicated in FIG. 1, having a thickness of about 0.75 mm. The plate 11 has an oblong rectangular shape, having a front long side 12, a back long side 13, and left 14 and right 15 short sides, as viewed from above. Machining of the plate 11 will form a knife body 21 with different features of the knife.

A cutting edge 22 is formed into the front long side 12, and guides 23 are provided on either side of the cutting edge 22, also being located in the front long side 12. The body 11 is provided with first angled sides 16 from the outer edge of the guides 23 towards the left 14 and right 15 short sides.

The back side 13 of the plate 11 has a short portion 18, which is parallel to the longitudinal extension of the knife. On either side of said short portion 18, second angled sides 17 extend inwards towards the centre of the body 21, making the body narrower towards the ends. The knife body is slightly wider at the location of attachment holes 24, 25 on either end of the body 21, adjacent the guides 23.

The cutting edge 22 is formed into an arrow shape, having a tip 26 in the centre thereof. The angle of the arrow shaped cutting edge 22, in relation to a direction that is perpendicular to the intended travel direction T of the knife, is denoted α, and this angle is approx. 1.5 degrees. The cutting edge 22 is serrated, and is further single-bevelled, see FIG. 3, where the bevel angle β is about 30 degrees between a bottom surface 27 and the cutting edge 22. The guide 23 is double-bevelled, and the bevel angle γ is about 30 degrees between the bottom surface 27 and one of the bevels, making the total angle of the bevel about 60 degrees.

The guides 23 protrude outside the cutting edge 22, as can be seen in FIG. 2. The distance the guides 23 protrude outside the tip 26 of the cutting edge 12 is denoted A, and this is approximately 1.0 mm. It can further be seen in FIG. 2 that the tip 26 does not protrude outside the starting point of the bevels of the guides 23.

The attachment holes 24, 25 are shaped differently, in that the left attachment hole 24 is circular and the right attachment hole 25 is elongated, having two half-circular walls being connected with straight walls. The elongated hole 25 allows the knife to be mounted even if the distance between corresponding projections on the pressure jaw varies slightly, due to manufacturing tolerances.

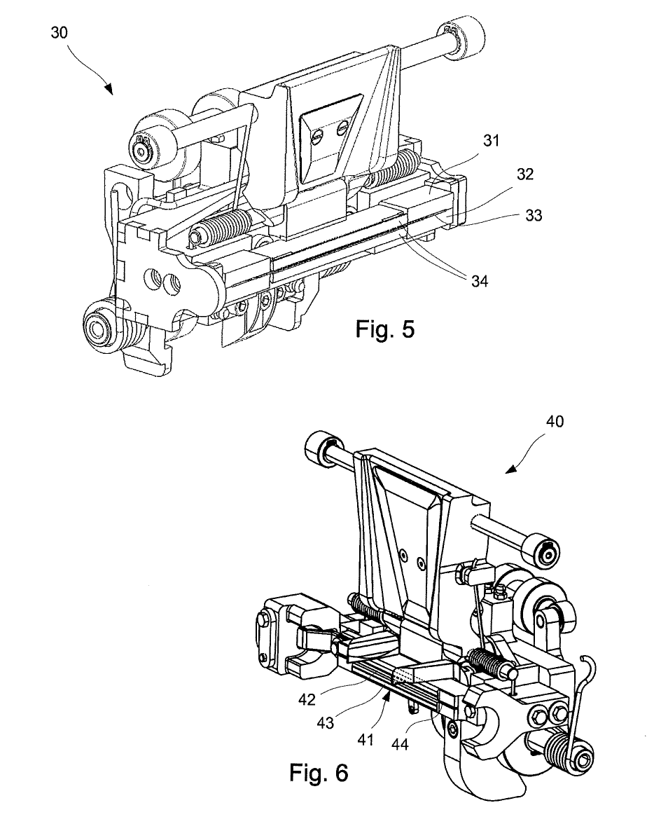

In FIG. 5, a pressure jaw 30 is shown, which in use will cooperate with a heating jaw. The pressure jaw 30 comprises two substantially identical pressure rails 31, 32, being placed on top each other. The pressure rails 31, 32 each has a track in which a sealing dolly 34 is arranged. The pressure rails 31, 32 are arranged on the pressure jaw a slight distance apart, such that a slot 33 is formed between the rails 31, 32. This slot 33 is formed to house the knife 10, and to allow said knife to exit out of the slot 33 during a cutting operation.

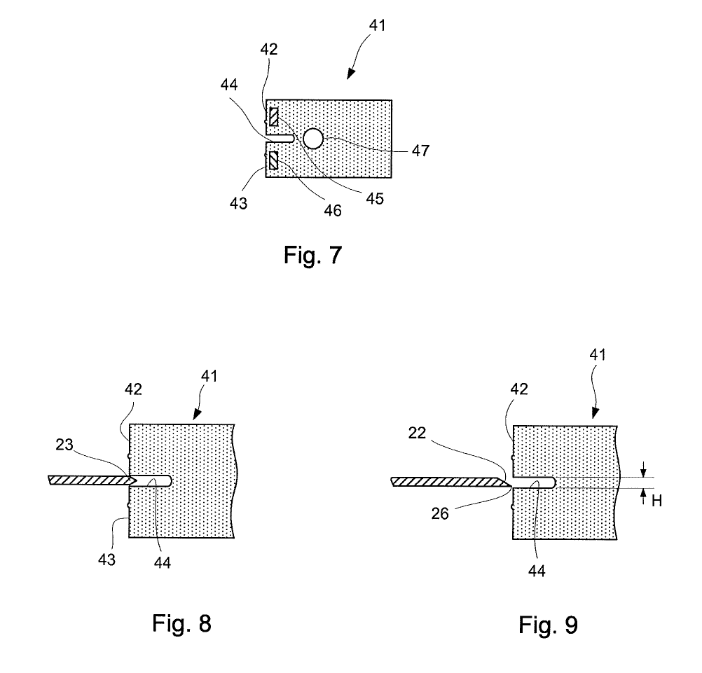

The height H of the slot 33 is larger than the thickness of the knife 10. In FIGS. 6, a heating jaw 40 is shown for interacting with the pressure jaw 30 during a sealing operation. The heating jaw 40 comprises an inductor 41, typically only comprising a shallow groove 44, into which the knife 10 can enter during the cutting action. The inductor further has an upper portion 42 and a lower portion 43, being separated by the groove 44, see also FIG. 7. The inductor 41 further comprises upper 45 and lower 46 conductors, for heating the packaging material during sealing, and a cooling conduit 47 to cool down the inductor 41.

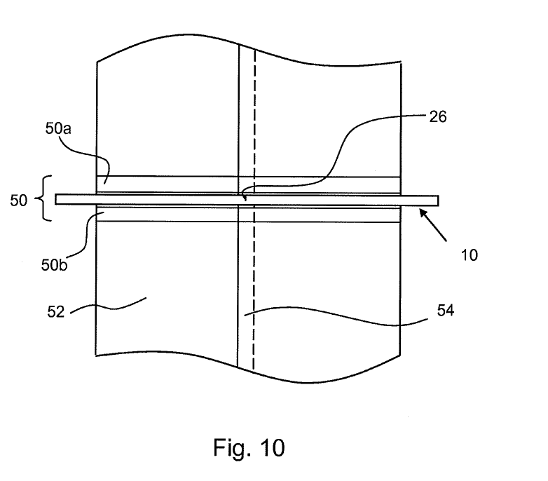

In use, the knife 10 is mounted in a holder in the pressure jaw 30. Said knife 10 is activated automatically by the reciprocating movement of the pressure jaw 30, e.g. through a cam arrangement. At the end of a sealing operation, wherein a sealing has been made in the tube of packaging material, the knife 10 is driven cross-wise to the tube, in the direction T, in order to separate the sealed tube into separate pillow-shaped packages. The knife enters in the centre of a transversal sealing zone of the tube of packaging material. The transversal sealing zone is shown in FIG. 10 and is denoted 5. It comprises two transversals seals 50a, 50b in between which the knife will act. The width of said sealing zone, crosswise to the extension of the tube, is not greater than the width of the serrated cutting edge 22.

During the cutting action, the knife 10 is brought towards the sealing zone. FIGS. 8 and 9 show the position of the guides 23 and the tip of the cutting edge 22, when the guides 23 have just fully entered the groove 44. The double-bevelled guides 23 easily enter the groove 44, and position the knife 10 accurately in the groove 44, see FIG. 9. The tip 26 of the cutting edge 22 does not enter the groove 44 until the guides 23 have fully entered the groove 44, as seen in FIGS. 8 and 9. Since the knife 10 is now accurately positioned in the groove 44, the single-bevelled cutting edge 22 enters the groove 44 while being fully guided by the guides 23. This guiding of the cutting edge 23 makes it possible to form the groove 44 with very tight tolerances and with only a very small clearance for the knife 10. This improves the cutting performance compared to having a wider slot.

In one aspect the invention provides a knife with a guide, being configured to be activated before the cutting edge, which controls an accurate positioning into a groove of the cutting edge. In one embodiment, the cutting edge is arrow-shaped having a central tip, making the cutting action gradual and requiring less force to push the knife through the packaging material. In one embodiment, the cutting edge is single-bevelled. In yet another aspect of the invention, the guide is double-bevelled.

As mentioned above the cutting edge 22 is arrow-shaped having a central tip 26. The use of the tip 26 will here be described in relation to FIG. 10. The position of the tip 26, being hidden in FIG. 10, is indicated with a short line. In use, when the knife 10 is approaching the transversal sealing zone 50 on the tube of packaging material 52, the tip 26 is configured to contact the packaging material first, before the rest of the cutting edge (22), and cut through a packaging material overlap area 54. The overlap area 54 is the area where the longitudinal edges of the web are overlapping each other and sealed, as mentioned in the introductory portion of the application. Due to the extra layer of packaging material the overlap area 54 will be the hardest to cut through in terms of force needed, and will be the area with the highest risk of delayed separation due to that more sticky polymer material is being present. By initiating the cut at the overlap area 54 with the tip 26 all the force can be concentrated in a single point and secure penetration by the knife 10. Further, since the tip 26 reaches the tube first, the time that the cut pieces will stay separated, with the knife 10 in between, will be as long as possible in the overlap area 54. This decreases the risk of the pieces adhering to each other again, and hence the risk of delayed separation is minimised.

The attachment holes 24, 25 can have other shapes than round and elongated. If the holes 24, 25 are shaped differently, and corresponding differently shaped attachment points are provided in the pressure jaw 30, the knife can only be mounted in one way. By the described configuration good cutting performance can be obtained. The left attachment hole 24 can e.g. be square, and the right attachment hole 25 can e.g. be triangular, and the pressure jaw 30 having correspondingly shaped attachment points.

Even though the pressure jaw 30 is shown comprising two pressure rails 31, 32, it is possible to form a similar arrangement from a single piece, or to form it from different pieces, being attached in different ways.

The knife 10 can be formed by casting, forging, grinding or milling, or a combination thereof, in a way known per se to the person skilled in the art.

Even though it is shown that the knife is mounted in the pressure jaw 30, it is possible to mount the knife in the heating jaw 40, and to have a shallow groove in the pressure jaw 30.

The knife 10 is described as being 0.75 mm thick, but it can be in the range between 0.5 and 1.25 mm. The single-bevelled cutting edge 22 is specified at 30 degrees, but it can be between 25 and 35 degrees. Correspondingly, the double-bevelled guides 23 are specified to have a tip angle of about 60 degrees, but this tip angle can be 40-80 degrees.

Sealing jaw is meant to describe either a pressure jaw or a heating jaw. A sealing jaw assembly designates a combination of a pressure jaw 30 and a heating jaw 40.

The above heating jaw 40 is described with an inductor, for induction heating, but it is of course possible to have other forms of heat sealing, such as impulse heating, constant heating or ultrasonic sealing, as is known to a person skilled in the art, without deviating from the invention.

All features described in connection with any aspect of the invention can be used with any other aspect of the invention. This means that the features a) single-bevelled cutting edge, b) arrow-shaped cutting edge, c) double-bevelled guide, d) differently shaped attachment holes, e) having one, two or more guides, etc. can be used individually or in any combination thereof.

Whilst the invention has been described with reference to a preferred embodiment, it will be appreciated that various modifications are possible within the scope of the invention.

In this specification, unless expressly otherwise indicated, the word ‘or’ is used in the sense of an operator that returns a true value when either or both of the stated conditions is met, as opposed to the operator ‘exclusive or’ which requires that only one of the conditions is met. The word ‘comprising’ is used in the sense of ‘including’ rather than in to mean ‘consisting of’.

1. Knife for a sealing jaw arrangement of a filling machine, said knife in use being provided in a first member, and designed to cooperate with a groove of a second member, the knife having a body being provided with a cutting edge on one side thereof configured to cut through a packaging material, said body further comprising a guide, said guide being configured to enter the groove for controlling a movement of the cutting edge into the groove, the guide being configured to enter the groove before the cutting edge enters the groove.

2. Knife according to claim 1, wherein two guides are provided on the body on either side of the cutting edge.

3. Knife according to claim 1, wherein the first member is a pressure jaw and the second member is a heating jaw.

4. Knife according to claim 1, wherein the cutting edge is single-bevelled.

5. Knife according to claim 1, wherein the guide is double-bevelled.

6. Knife according to claim 1, wherein the cutting edge has an arrow shape with a tip.

7. Knife according to claim 6, wherein the tip is configured to contact the packaging material first, before the rest of the cutting edge, and cut through a packaging material overlap area.

8. Knife according to claim 7, wherein the tip is located in the middle of the cutting edge.

9. Knife according to claim 1, wherein the cutting edge is serrated.

10. Knife according to claim 1, wherein the body is configured to have asymmetric attachment points.

11. Knife according to claim 10, wherein one of the attachment holes of the body has a different shape than the other attachment hole.

12. Sealing jaw assembly comprising a pressure jaw and a heating jaw, having a knife according to claim 1.

13. A knife configured to be mounted in a first jaw which cooperates with a second jaw that includes a groove, one of the first and second jaws being a heating jaw so that cooperation between the first and second jaws produces a sealed zone in packaging material which is subsequently cut by the knife, the knife comprising:
a plate possessing an oblong rectangular shape;
the plate including front and back sides at oppositely positioned relatively longer sides of the oblong rectangular shape, the plate also including left and right sides at oppositely positioned relatively shorter sides of the oblong rectangular shape;
the front side of the plate including a cutting edge and two guides, the cutting edge being positioned between the two guides, the cutting edge and the guides projecting in a forward direction away from the back side of the plate;
the knife being configured to be mounted for reciprocating movement in the first jaw so that the knife: i) moves towards the second jaw while the sealed zone of the packaging material is positioned between the first and second jaws; ii) cuts the sealed zone in the packaging material; iii) enters the groove in the second jaw; and then iv) moves away from the second jaw; and
the guides projecting further in the forward direction than the cutting edge so that the guides enter the groove in the second jaw before the cutting edge enters the groove to control movement of the cutting edge into the groove.

14. The knife according to claim 13, wherein the cutting edge is single-bevelled.

15. The knife according to claim 14, wherein each guide is double-bevelled.

16. The knife according to claim 13, wherein each guide is double-bevelled.

17. The knife according to claim 13, wherein the cutting edge possesses an arrow shape with a tip, the being located in a middle of the cutting edge.

18. The knife according to claim 13, wherein the cutting edge is serrated.

19. The knife according to claim 13, wherein the pate includes two attachment holes configured to attach the knife to the first jaw, the two attachment holes possessing different shapes.

20. A sealing jaw assembly comprising:
first and second jaws, the second jaw including a groove;
one of the first and second jaws being a pressure jaw and the other of the first and second jaws being a heating jaw, the first and second jaws being relatively movable towards one another while packaging material is positioned between the first and second jaws to produce a sealed zone in the packaging material;
a knife mounted for reciprocating movement in the first jaw to move toward the groove in the second jaw while the sealed zone of the packaging material is positioned between the first and second jaws to cut the sealed zone;
the knife comprising:
a plate possessing an oblong rectangular shape;
the plate including front and back sides at oppositely positioned relatively longer sides of the oblong rectangular shape, the plate also including left and right sides at oppositely positioned relatively shorter sides of the oblong rectangular shape;
the front side of the plate including a cutting edge and two guides, the cutting edge being positioned between the two guides, the cutting edge and the guides projecting in a forward direction away from the back side of the plate; and
the guides projecting further in the forward direction than the cutting edge so that the guides enter the groove in the second jaw before the cutting edge enters the groove to control movement of the cutting edge into the groove.
